(19) United States
(12) Patent Application Publication
(10) Pub. No.: US 2002/0104092 A1
(43) Pub. Date: Aug. 1, 2002

(54) Image distribution method and apparatus and controller

(76) Inventors: Hideo Arai, Tokyo (JP); Takashi Nishimura, Tokyo (JP); Tetsuya Oosawa, Tokyo (JP); Akira Motosu, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/823,064

(22) Filed: Mar. 30, 2001

(30) Foreign Application Priority Data
Jan. 30, 2001 (JP) 2001-021024

(51) Int. Cl. H04N 7/173; H04N 5/445

(52) U.S. Cl. 725/87; 725/42

(57) ABSTRACT

In on-demand distribution, suitable image information corresponding to a receiver terminal and a distribution line is distributed and, even when a user uses a plurality of receiver terminals, distribution can be interrupted and resumed. By selecting and/or processing resolution information, advertisement image information, text information, and reproduction time information of the received-image information based on information relating to a receiver terminal and information relating to a distribution line provided separately, an image distribution apparatus distributes suitable image information corresponding to the receiver terminal and distribution line. When the distribution was interrupted, the apparatus stores a break point at which the distribution was interrupted for each user. When distribution of programs is carried out according to priorities thereof, if the program already distributed after the interruption and before the resumption has newly-received contents, then the apparatus reconstructs the programs to be distributed, including the program having the newly-received contents.

### BACKGROUND OF THE INVENTION

The present invention relates to an image distribution apparatus for distributing image information on demand from a user.

As a two-way network develops, on-demand distribution to distribute an image on request from a user has been put to practical use. In the on-demand distribution, unlike one-way distribution such as conventional television broadcast, a user can get an image at any time when the user wants to see it.

In the on-demand distribution, a more easy-to-use distribution system can be formed by putting various thoughts into the distribution method. In a technique as disclosed in JP-A-11-004252 (which will be referred to as literature 1, hereinafter), as an example, when it is desired to transmit data to a terminal such as a portable phone having only a relatively low speed processing capability via a relatively low speed distribution line, data to be transmitted at a server is converted to data of a specified size, thus enabling display of the data in a practical quality and time.

In a technique disclosed in JP-A-11-112955 (which will be referred to as literature 2, hereinafter), in a remote conference system, terminals exchange information on the display size of an image from the party terminal, and the amount of data to be transmitted is adjusted according to the display size of the image at the party terminal (the image to be transmitted is changed in compression rate) to thereby increase a line operating efficiency.

Also disclosed in JP-A-2-294183 (referred to as literature 3, hereinafter) is a technique wherein information about a break point in a motion picture program so far delivered in the past at each terminal is stored in motion image center, so that, when a user of the terminal wants to resume it, the center reads out the motion image program therefrom and distributes it to the terminal, whereby the terminal can restart the past-delivered program from the break position.

### SUMMARY OF THE INVENTION

As portable terminal and radio or wireless communication network are developed in these years, such a usage method has been put to practical use that an identical user receives, at home at a fixed television set, image information distributed via a cable TV network and the user also receives, at a portable terminal from the road (away from home), an image distributed via a radio or wireless transmission line. Correspondingly, there has been opened such applications that the above prior arts cannot cope with it.

The display screen of the fixed television set has been increased in its size and resolution. Further, the transmission capacity of the cable television network has also been increased. For this reason, the demand to the fixed television set is to the capability of displaying fine information on its larger display screen while avoiding restrictions on the quantity or size of the information. The portable terminal, which has a small display screen, on the other hand, is required not to have a so-high image resolution but to have a small amount of information due to its wireless distribution restriction, that is, to have a distribution system of small image size and small information quantity.

With respect to the contents of image information, different contents are required between the television set and portable terminal. For example, with respect to a news article, it is desirable in the case of the fixed TV set to transmit more detailed information together with a clear image thereto even with a sufficient time because the user usually can watch it with a sufficient time. Meanwhile, in the case of the portable terminal, its user usually sees it during intervals between his transportation times, and thus it is desirable to distribute information about an abstract of the news article in a short time. For example, in the case of the fixed TV set, when image distribution contains advertisement image information, it is desirable for the advertisement image information to be oriented to family because families watch the image. In the case of the portable terminal, on the other hand, it is desirable, for example, for the contents of the advertisement image information to be oriented to business because the user of the portable terminal likes business. In this way, such advertisement image information varies from receiver terminal to receiver terminal.

The techniques disclosed in the literatures 1 and 2, when data transmission is carried out via a relatively low-speed distribution line to a terminal which can have only a relatively low-speed processing ability, merely convert data to be transmitted from a server into a specified data size or merely adjust the amount of data to be transmitted according to the image display size at the party terminal (change the compression rate of the image to be transmitted). In other words, these techniques fail to pay consideration to the fact that the contents of image information to be distributed is selected and/or processed depending on the image receiving terminal as mentioned above.

Meanwhile, with regard to even the function of re-delivering the program delivered and stored in its break point in the past from the break point on, the prior art technique of the literature 3 cannot cope with it in some cases, when consideration is paid to the cooperation of the fixed TV set and portable terminal. For example, when some of the users want to use both the fixed TV set and portable terminal as when some users watch the program and listens thereto on the TV set together with their family but some want to see the program on his portable terminal from its break point, the aforementioned technique cannot cope with it only by storing the break point for each terminal. Further, after a user assigned news programs priorities for selection, watched them and listened thereto until a break point, when he again wants to watch and listen to them on his portable terminal after a long-time passage due to his transportation or move, there may occur such a situation that, due to coming latest news with passage of time, it does not become important to watch and listen to the original news programs with the assigned priorities from the breakpoint, and instead it becomes important as necessary to replace the old news by new ones with new priorities and to listen to them from the break point.

In this way, when consideration is paid to the cooperation of the fixed TV set and portable terminal, it is desirable to distribute image information having image sizes, image solutions and contents different depending on respective receiver terminals, and further it is desirable not to store a break point for each receiver terminal but to store the break point for each user.

It is therefore a first object of the present invention to provide an image distribution apparatus which can solve the above problems in the prior art and can select and/or process and distribute image information according to receiver terminals. A second object of the present invention is to provide an image distribution apparatus which, even when a user uses a plurality of receiver terminals such as a fixed TV set and a portable terminal, can efficiently distribute suitable image information thereto.

In accordance with the present invention, the first object is attained by providing an image distribution apparatus which receives image information from an image supply source, receives operation information including information for specifying a program to be distributed, information on a receiver terminal and information on a distribution line, specifies the program to be distributed on the basis of the program specifying information, operates image information of the specified program on the basis of the receiver terminal information (which will be described below), selects the suitable distribution line on the basis of the distribution line information for distribution. The operatings include selection of suitable one of the image information, when including a plurality of types of image information inputted to a single program, on the basis on the receiver terminal information, and also includes, in the absence of suitable image information, processing of the received image information into image information suitable for the receiver terminal information.

In accordance with the present invention, the above second object is attained by providing an image distribution apparatus which, when distribution of a program is interrupted or broken, stores a break point indicative of the interrupted position of the program for each user. In the case where a program is interrupted and thereafter the program distribution is again resumed, when there are present a remaining part of the program being distributed at the break point and a newly added part of the already-distributed program when compared with the latest program at the resumption time, the apparatus distributes the remaining and newly added contents of the program according to a priority order.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of an image distribution apparatus in accordance with an embodiment of the present invention;

FIG. 2 is a block diagram of an example of an image selecting/processing unit 241 in the image distribution apparatus of the present invention;

FIG. 3 is a block diagram of an example of a resolution selector/processor 242 of the image selecting/processing unit 241 in the image distribution apparatus of the present invention;

FIG. 4 is a block diagram of an example of an advertisement image selector 243 of the image selecting/processing unit 241 in the image distribution apparatus of the present invention;

FIG. 5 is a block diagram of an example of a text selector/processor 244 of the image selecting/processing unit 241 in the image distribution apparatus of the present invention;

FIG. 6 is a block diagram of an example of a display type depended image selector/processor 245 of the image selecting/processing unit 241 in the image distribution apparatus of the present invention;

FIG. 7 is a block diagram of an example of an image time selector/processor 246 of the image selecting/processing unit 241 in the image distribution apparatus of the present invention;

FIGS. 8A and 8B show an example of tables stored in a storage in the image distribution apparatus of the present invention, wherein 8A shows an example of a table of information mainly on programs to be distributed and 8B shows an example of a table of information mainly on receiver terminals;

FIG. 9 shows an example of a row of image programs distributed according to priorities by the image distribution apparatus of the present invention;

FIG. 10 is a diagram showing an example of operations of the image distribution apparatus of the present invention when distributing image information according to a priority order; and

FIG. 11 is a block diagram of an image distribution apparatus in accordance with another embodiment of the present invention.

### DETAILED DESCRIPTION OF THE EMBODIMENTS

The present invention will be explained in connection with embodiments of the invention by referring to the accompanying drawings.

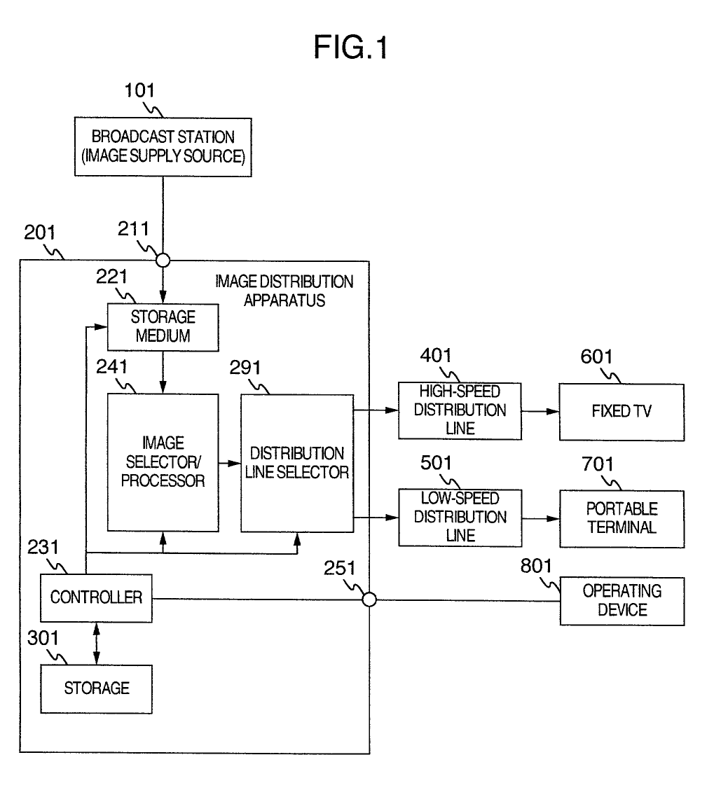

FIG. 1 is a block diagram of an arrangement of an image distribution apparatus in accordance with an embodiment of the present invention. In the drawing, an image supply source 101 is, for example, a broadcast station which delivers image information to the distribution apparatus. An image distribution apparatus 201 selects and/or processes and distributes image information on user's demand. A high-speed distribution line 401 is a distribution line such as a cable distribution line which distributes data at a high speed. A low-speed distribution line 501 is a distribution line such as a wireless distribution line which distributes data at a low speed. A fixed TV set 601, which has a relatively large font display screen, is a receiver terminal which is usually fixed at home to watch and listen to image information. A portable terminal 701, which has a relatively small size display screen, is a receiver terminal which is used for a private person on his move to watch and listen to image information. An operating device 801 is used to give various instructions to the image distribution apparatus 201.

In the image distribution apparatus 201, an image input part 211 functions to receive image information from the image supply source 101. A storage medium 221 as an image storage acts to store the received image information therein. A controller 231 performs control over respective components within the image distribution apparatus 201. A image selecting/processing circuit 241 as any of an image selector, an image processor, and an image selector/processor functions to select and/or process image information to be distributed into suitable information on user's request. An operating information input part 251 receives operating information from the operating device 801. A distribution line selection circuit 291 as a distribution line selection unit selects a distribution line through which the image information is to be distributed on user's demand. A storage 301 stores therein the received operating information and information necessary for distribution of other image information.

Although the cable distribution line has been illustrated as the high-speed distribution line 401 and the wireless distribution line has been illustrated as the low-speed distribution line 501 herein, the present invention is not limited to the specific examples. A distribution line having actually a high transmission speed is used as the high-speed distribution line 401, while a distribution line having actually a low transmission speed is used as the low-speed distribution line 501 regardless of the wired or wireless type. Further, two distribution lines are illustrated in the drawing, three or more distribution lines may be provided. Further, though the fixed TV set 601 having a relatively large-font display screen is connected downstream of the high-speed distribution line 401 and the portable terminal 701 having a relatively small size display screen is connected downstream of the low-speed distribution line 501 in the drawing, the present invention is not limited to the specific example. Regardless of the fixed or portable type, a receiver terminal having a large-font display screen may be connected to the high-speed distribution line 401 and a receiver terminal having a relatively small size display screen may be connected to the low-speed distribution line 501. In addition, although the operating device 801 has been illustrated and explained as an independent exclusive device herein, it may be incorporated in the fixed TV set 601 or portable terminal 701. Details of the operating device 801 will be explained later.

Explanation will be briefly made now as to a summary of the operation of the image distribution apparatus of the present embodiment and detailed explanation thereof will be made later.

Image information is first input from the image supply source 101 such as a broadcast station via the image input part 211 to the operating device 201. The input image information is stored in the storage medium 221. In this connection, the image information for one program sent from the broadcast station may include, for example, a plurality of types of image information having different resolutions, a plurality of types of image information suitable for different sizes of display screens, and a plurality of types of image information having different advertisement image information. In this case, the plurality of types of image information are stored in the storage medium.

The user operates the operating device 801 to instruct the image distribution apparatus 201 to distribute a desired program. That is, operating information including a user ID, a program ID, receiver terminal information and distribution line information is transmitted via the operating information input part 251 to the controller 231 of the image distribution apparatus 201. The receiver terminal information is information, e.g., about fixed or portable type, resolution and physical size of the display screen, installation place, processing capability, distribution line connected thereto, etc. The distribution line information is information, e.g., about wired or wireless type, transmission speed, receiver terminal connected thereto, etc.

The controller 231, when receiving the operating information, refers to a file previously stored in storage 301 and identifies the user on the basis of the user ID. And After identifying the user, the controller 231 searches the storage medium 221 for image information of a program stored therein and corresponding to the received program ID, and inputs its searched image information to the image selecting/processing circuit 241. The image selecting/processing circuit 241, on the basis of the receiver terminal information and distribution line information, selects and/or processes suitable one of the received image information and outputs it to the distribution line selection circuit 291. The circuit 291, on the basis of the distribution line information, delivers the input image information to the suitable distribution line.

Explanation will be made in detail in the following embodiment in connection with an example where the controller 231 searches for the program image information and the image selecting/processing circuit 241 selects, on the basis of the searched image information, image information corresponding to the receiver terminal information. However, it is also possible that the image selecting/processing circuit 241 searches the image information storage for program image information of the image information stored in the storage corresponding to the received program ID and to the receiver terminal information, and then outputs it to the distribution line selection circuit 291. Explanation of such an arrangement holds true also for the detailed embodiments which follows.

The image information thus distributed is transmitted via the suitable distribution line to the suitable receiver terminal. And the receiver terminal, when receiving the image information, can display the image information and the user can watch and listen to the program.

Next, the image selecting/processing circuit 241 as one of features of the image distribution apparatus 201 in the present embodiment will be detailed.

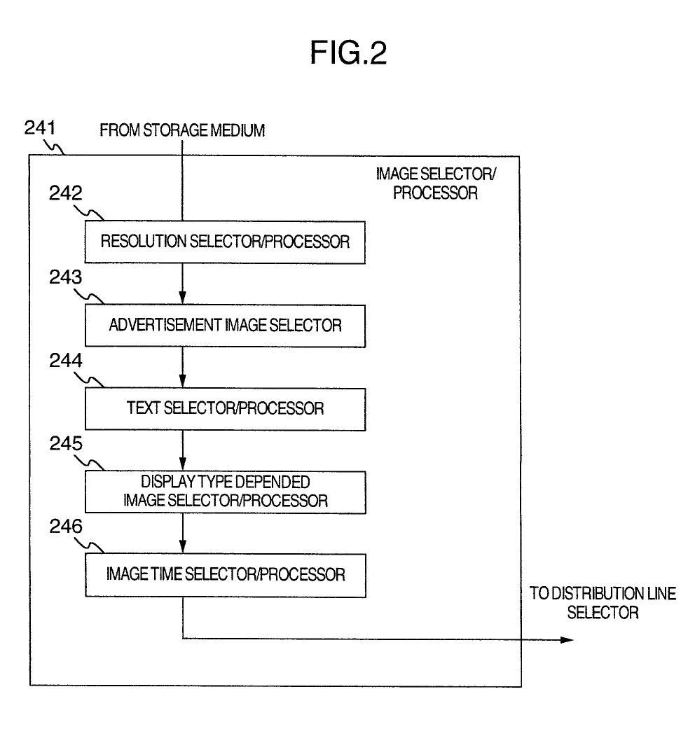

FIG. 2 is a detailed block diagram of an example of the image selecting/processing circuit 241 which includes circuits 242 to 246 as its constituent components. As already explained above, the image selecting/processing circuit 241 is controlled by the controller 231 on the basis of the operating information including the receiver terminal information and distribution line information.

The image information stored in the storage medium 221 is first input to the resolution selecting/processing circuit 242 to be selected and/or processed therein to obtain image information having a suitable resolution. The resolution selecting/processing circuit 242 outputs the obtained image information to the advertisement image selecting circuit 243.

Next, the advertisement image selecting circuit 243, when receiving the image information from the resolution selecting/processing circuit 242, extracts multiplexed program and advertisement image parts from the received image information, selects one of the extracted advertisement image parts according to the operating information, again achieves multiplexing between the program part and the selected advertisement image part to obtain multiplex image information multiplexed with the suitable advertisement image information, and then outputs it to the text selecting/processing circuit 244.

And the text selecting/processing circuit 244, when receiving the multiplex image information from the advertisement image selecting circuit 243, extracts text information from the multiplex information, selects and/or process suitable part of the extracted text information according to the operating information, and again achieve multiplexing between the extracted text information and image information to obtain multiplex image information multiplexed with the suitable text information, and then outputs it to the display type depended image selecting/processing circuit 245.

Subsequently the display type depended image selecting/processing circuit 245, when receiving the image information from the text selecting/processing circuit 244, selects and/or processes an image for a large or small display screen according to the operating information to obtain suitable image information corresponding to the display screen, and then outputs it to the image time selecting/processing circuit 246.

Finally, the image time selecting/processing circuit 246, when receiving the image information from the different display image selecting/processing circuit 245, selects and/or processes the received image information according to the operating information to obtain image information having a long or short reproduction time suitable for the receiver terminal or user, and then outputs it to the distribution line selection circuit 291.

In this manner, the resolution, advertisement image information, text information, contents, reproduction time, etc. can be selected and/or processed according to the operating information to distribute image information corresponding to the receiver terminal and distribution line.

In this case, the resolution selecting/processing circuit 242, advertisement image selecting circuit 243, text selecting/processing circuit 244, different display image selecting/processing circuit 245 and image time selecting/processing circuit 246 are illustrated as sequentially connected as an example. However, the present invention is not limited to this connection sequence but these circuits may be connected in an arbitrary order. Further, provision of all the circuits are not necessarily required and necessary ones of the circuits can be employed according to its application purpose or the like.

The respective circuits of the image selecting/processing circuit 241 will next be explained in more detail.

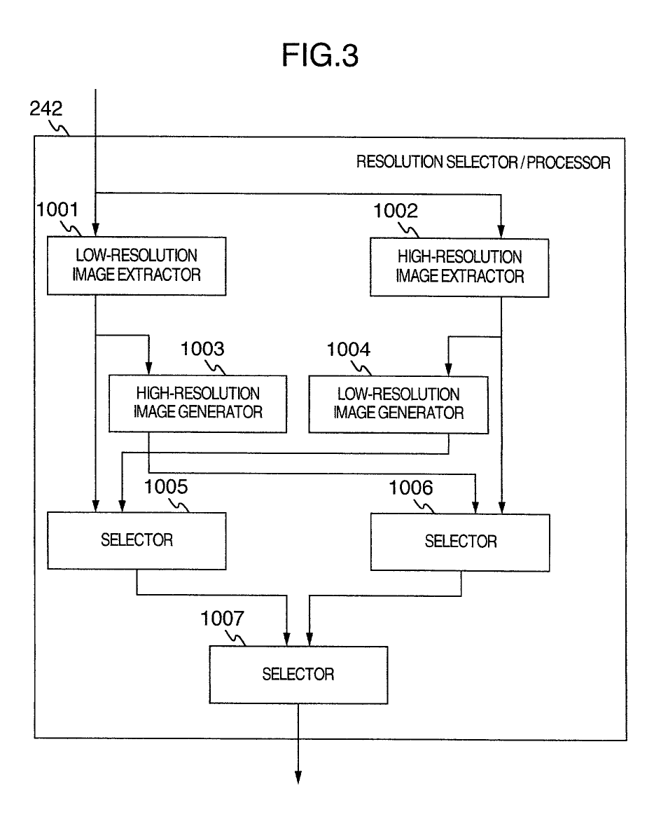

FIG. 3 is a block diagram of an example of the resolution selecting/processing circuit 242. When a receiver terminal capable of displaying image information on a display screen with a high resolution is connected to a high-speed distribution line, the resolution selecting/processing circuit 242 distributes, to the receiver terminal, high-resolution image included in the received image information or distributes high-resolution image generated from a low-resolution image included in the received image information. In the other cases than the above, the resolution selecting/processing circuit 242 conversely distributes a low-resolution image included in the received image information or distributes a low-resolution image generated from high-resolution image included in the received information. The resolution selecting/processing circuit 242 acts to select and/or process the received image information to realize such distribution as mentioned above.

Explanation will be briefly made in connection with a specific example. It is now assumed, for example, that image information transmitted from the image supply source 101 and stored in the storage medium 221 contains a high-resolution image having 800 pixels in its horizontal resolution and 600 pixels in its vertical resolution (which will be abbreviated merely to “800*600”, hereinafter) and also contains a low-resolution image having 400*300 pixels. Then when a receiver terminal having a display screen of 800*600 is connected to a high-speed distribution line, the resolution selecting/processing circuit 242 selects and outputs the high-resolution image of 800*600; whereas when the receiver terminal having a display screen of 400*300 is connected to a low-speed distribution line, the resolution selecting/processing circuit 242 selects and outputs a low-resolution image of 400*300. Meanwhile, when the image information contains only the high-resolution image of 800*600 and the receiver terminal having the display screen of 400*300 is connected to the low-speed distribution line, the resolution selecting/processing circuit 242 processes the high-resolution image of 800*600 to a low-resolution image of 400*300 and then outputs it. In this way, the resolution selecting/processing circuit 242 acts to select and/or process and output an image having a resolution matching the resolution of the display screen of the receiver terminal.

In FIG. 3, a low-resolution image extraction circuit 1001 extracts a low-resolution image from the received image information. A high-resolution image extraction circuit 1002 extracts a high-resolution image from the received image information. A high-resolution image generation circuit 1003 generates a high-resolution image from a low-resolution image. A low-resolution image generation circuit 1004 generates a low-resolution image from a high-resolution image. A selection circuit 1005 selects one of the extracted low-resolution image and received from the low-resolution image extraction circuit 1001 and the generated low-resolution image received from the low-resolution image generation circuit 1004. Another selection circuit 1006 selects one of the extracted high-resolution image received from the high-resolution image extraction circuit 1002 and the generated high-resolution image received from the high-resolution image generation circuit 1003. Another selection circuit 1007 selects one of the low-resolution image received from the selection circuit 1005 and the high-resolution image received from the selection circuit 1006. These circuits are controlled by the controller 231 on the basis of the receiver terminal information included in the operating information, in particular, the display screen resolution information thereof and on the basis of the distribution line information included in the operating information, in particular, the transmission speed information thereof.

When a receiver terminal, whose user wants to watch and listen to a program and which has a display screen capable of image information with a high resolution, is connected to the high-speed distribution line, the operation is as follows. That is, when the image information contains a high-resolution image, the high-resolution image extraction circuit 1002 extracts the high-resolution image therefrom and outputs it to the selection circuit 1006. And the selection circuit 1006 selects the high-resolution image and outputs it to the selection circuit 1007. Finally the selection circuit 1007 selects the high-resolution image, whereby an output of the resolution selecting/processing circuit 242 becomes eventually the extracted high-resolution image. When the image information contains no high-resolution image, the low-resolution image extraction circuit 1001 extracts a low-resolution image therefrom and the high-resolution image generation circuit 1003 generates a high-resolution image from the low-resolution image. And the selection circuit 1006 selects the generated high-resolution image and outputs it to the selection circuit 1007. Finally the selection circuit 1007 selects the generated high-resolution, whereby an output of the resolution selecting/processing circuit 242 becomes a generated high-resolution image.

When the receiver terminal, whose user wants to watch and listen to a program and which has a display screen capable of displaying image information with a high resolution, is not connected to the high-speed distribution line, as opposed to the above case; the operation is as follows. That is, when the image information contains the low-resolution image, the low-resolution image extraction circuit 1001 extracts the low-resolution image therefrom and outputs it to the selection circuit 1005. And the selection circuit 1005 selects the low-resolution image and outputs it to the selection circuit 1007. Finally, the selection circuit 1007 selects the low-resolution image, whereby an output of the resolution selecting/processing circuit 242 becomes eventually the extracted low-resolution image. When the image information contains no low-resolution image, the high-resolution image extraction circuit 1002 extracts the high-resolution image therefrom, the low-resolution image generation circuit 1004 generates a low-resolution image from the high-resolution image. And the selection circuit 1005 selects the generated low-resolution image and outputs it to the selection circuit 1007. Finally the selection circuit 1007 selects the generated low-resolution image, whereby an output of the resolution selecting/processing circuit 242 becomes eventually the generated low-resolution image.

As a method for extracting low- and high-resolution images in the low-resolution image extraction circuit 1001 and high-resolution image extraction circuit 1002, there are several methods which follow. Firstly, when image information is of a digital image type such as motion image and voice compression standards H.262 (popularly called MPEG2 system) prescribed in “ITU-T White Book, Audiovisual/Multimedia-Associated Recommendations”, The ITU Association of Japan, Inc., published on Feb.18, 1995, pp. 375-595 (referred to as the literature 4, hereinafter), the image information can be classified according to the image size by extracting the image size described in the digital signal. Further, when the image information is distributed as attached thereto with an auxiliary signal indicative of an image size at a broadcast station, the extraction can also be realized with use of the attached signal. As a method for generating a high-resolution signal from a low-resolution signal in the high-resolution image generation circuit 1003, there is known a technique such as pixel interpolation or line interpolation. As a method for generating a low-resolution signal from a high-resolution signal in the low-resolution image generation circuit 1004, there is known a technique such as pixel thinning-out or line thinning-out.

As has been explained above, with the present arrangement, even either when the image information received from the image supply source 101 such as a broadcast station contains only a high-resolution image or only a low-resolution image or even when the image information contains both of the high-resolution image and low-resolution image, the high-resolution image can be distributed to a receiver terminal having a display screen capable of displaying it with a high resolution is connected to the high-speed distribution line, and the low-resolution image can be distributed to the other receiver terminals. Accordingly, efficient distribution can be realized.

Although the present invention has been arranged to be able to cope with it even when any one of the high-resolution image and low-resolution image is received from the image supply source 101 such as a broadcast station, the arrangement may be modified as necessary. For example, it is possible that, when only the high-resolution signal is distributed from the image supply source 101 such as a broadcast station, the low-resolution image extraction circuit 1001 and high-resolution image generation circuit 1003 can be removed. Further, explanation has been made in connection with the case where the resolution of image information has two level resolutions of high and low, but the number of resolution levels may be increased as necessary. That is, the present invention can receive an image with any resolution. And when the image information with any resolution contains an image with a suitable resolution, the present invention can extract the image therefrom and output it; whereas, when the image information contains no such image, the present invention can generate an image having a suitable resolution from an image having the closest resolution and output it.

Though explanation has been made in connection with the case where it is possible to both select and process image information, the present invention may carry out only one of the both. For example, when a plurality of image information for a single program are distributed from a broadcast station, the present invention may be arranged to have only a unit for select the image information and to have no unit for processing the image information.

Conversely, when a single piece of image information always for a signal program is distributed from a broadcast station, for example, the unit for selecting the image information is unnecessary and the present invention can be arranged to have only the unit for processing the image information. Explanation will be made in connection with a case where the present invention has both of the selecting and processing units. However, even in this case, it is not necessarily required to have the both, and only one of the both may be provided as necessary.

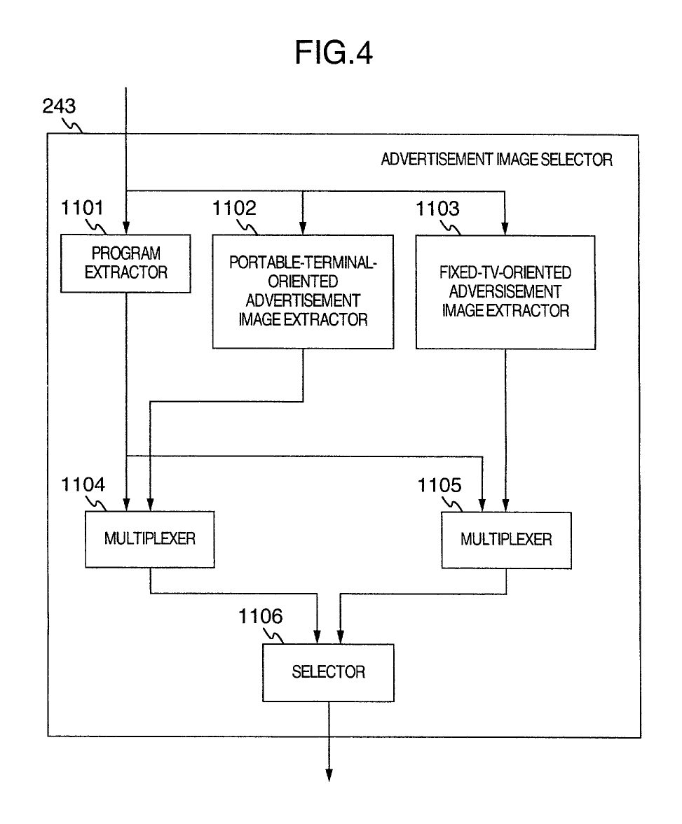

FIG. 4 is a detailed block diagram of an example of the advertisement image selecting circuit 243. The advertisement image selecting circuit 243 is used to realize distribution of portable-terminal-oriented advertisement image information to the portable terminal 701 while distribution of TV-oriented advertisement image information to the fixed TV set 601.

Explanation will be made below on the assumption that image information contains a program part, portable-terminal-oriented advertisement image information, TV-oriented advertisement image information all in a multiplexed form. In this connection, the portable-terminal-oriented advertisement image information is, for example, private-person-oriented advertisement image information; while, the TV-oriented advertisement image information is, for example, home-oriented advertisement image information. However, the present invention is not limited to the specific example. For example, when single private person watches and listens to the advertisement image information on a fixed TV set, the advertisement image information may be not the home-oriented one but private-person-oriented one. Accordingly, when the user issues an instruction about the advertisement image information, it is best to receive the instruction preferentially.

In FIG. 4, a program extraction circuit 1101 extracts a program part from the received multiplexed image information. A portable-terminal-oriented advertisement image information extraction circuit 1102 extracts a portable-terminal-oriented advertisement image part from the multiplexed image information. A TV-oriented advertisement image information extraction circuit 1103 extracts a TV-oriented advertisement image part from the multiplexed image information. A multiplexing circuit 1104 multiplexes the program part and portable-terminal-oriented advertisement image part to generate image information oriented to the portable terminal. A multiplexing circuit 1105 multiplexes the program part and TV-oriented advertisement image part to generate image information oriented to the fixed TV set. A selection circuit 1106 selects one of the portable-terminal-oriented image part received from the multiplexing circuit 1104 and the TV-oriented image part received from the multiplexing circuit 1105. These circuits are controlled by the controller 231 on the basis of the information about whether the receiver terminal is of the portable or TV type, in particular, of the receiver terminal information in the operating information and on the basis of user's instruction about advertisement image information included in the operating information.

When the user uses the portable terminal for his watching and listening and he give no special instruction about advertisement image information, and when the user issues an instruction to set the advertisement image information to be oriented to the portable terminal type, the operation is as follows. That is, the program extraction circuit 1101 extracts a program part from the received image information, and the portable-terminal-oriented advertisement image information extraction circuit 1102 extracts a terminal-oriented advertisement image part from the received image information. And the multiplexing circuit 1104 multiplexes the program and portable-terminal-oriented advertisement image part to generate portable-terminal-oriented image information. Next the selection circuit 1106 selects and outputs the portable-terminal-oriented image information. As a result, the output of the advertisement image selecting circuit 243 becomes eventually the image information multiplexed with the portable-terminal-oriented advertisement image information.

When the user uses a fixed TV set as a receiver terminal for his watching and listening and he issues no special instruction about advertisement image information, and when the user issues an instruction to set the advertisement image information to be oriented to fixed TV set, the operation is as follows. That is, the program extraction circuit 1101 extracts a program part from the received image information, and the TV-oriented advertisement image information extraction circuit 1103 extracts a TV-oriented advertisement image part from the received image information. And the multiplexing circuit 1105 multiplexes the program and TV-oriented advertisement image part to generate TV-oriented image information. The selection circuit 1106 next selects and outputs the TV-oriented image information. As a result, the output of the advertisement image selecting circuit 243 becomes eventually the image information multiplexed with the TV-oriented advertisement image information.

An example of the extracting method in the program extraction circuit 1101, portable-terminal-oriented advertisement image information extraction circuit 1102 and TV-oriented advertisement image information extraction circuit 1103 is to perform the extracting operation with use of an identification signal received together with image information or an identification signal attached to a packet having image information stored therein.

As has been explained above, with the present arrangement, advertisement image information suitable for the user of the selected receiver terminal can be delivered. Accordingly, the advertisement image information can be delivered to the user who may become a customer to an entrepreneur as a supplier of the advertisement image information; whereas the user can accept advertisement image information which attracts his interest with a high possibility.

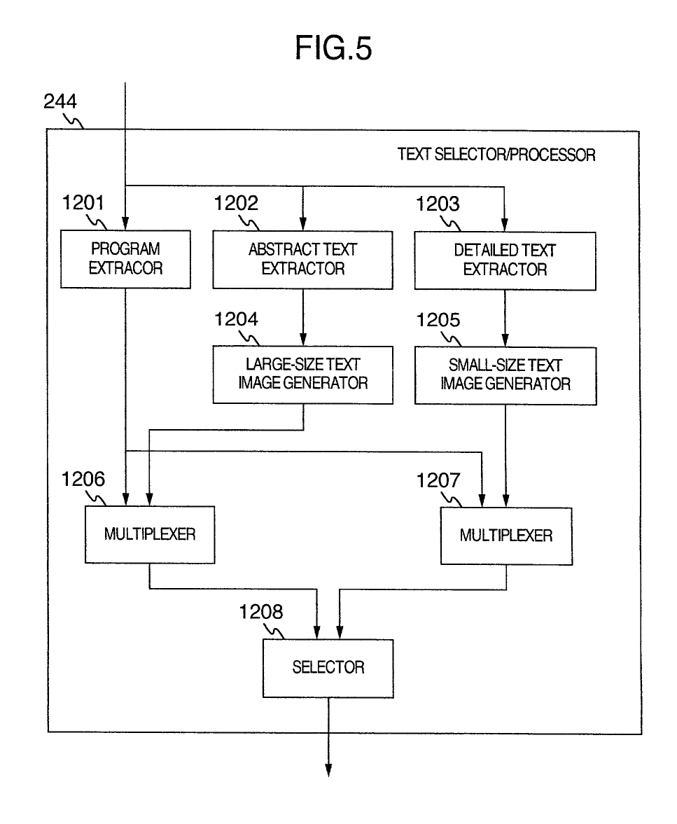

FIG. 5 is a detailed block diagram of an example of the text selecting/processing circuit 244. The text selecting/processing circuit 244 is arranged so as to distribute image information to a receiver terminal having a display screen even small but capable of displaying easy-to-see large-size text of the information; whereas, so as to distribute image information to a receiver terminal having a large display screen capable of displaying thereon small-size text of the information to allow the user to see much information at a time. For the purpose of realizing such distribution as mentioned above, the text selecting/processing circuit 244 selects and/or processes text information multiplexed in image information.

In FIG. 5, a program extraction circuit 1201 extracts a program part multiplexed in the received image information therefrom. An abstract text extraction circuit 1202 extracts abstract text information multiplexed in the image information oriented to a receiver terminal having a small display screen. A detailed text extraction circuit 1203 extracts detailed text information multiplexed in image information oriented to a receiver terminal having a large display screen. A large-size text image generation circuit 1204 generates a display made of a large-size text. A small-size text image generation circuit 1205 generates a display made of a small-size text. A multiplexing circuit 1206 multiplexes the program part and large-size text image for the receiver terminal having a small display screen. A multiplexing circuit 1207 multiplexes the program part and small-size text image for a receiver terminal having a large display screen. A selection circuit 1208 selects one of the image information of the small-screen receiver terminal from the multiplexing circuit 1206 and the image information of the large-screen receiver terminal from the multiplexing circuit 1207. These circuits are controlled by the controller 231 on the basis of information about the resolution and physical size of the display screen of the receiver terminal included in receiver terminal information of the operating information. In this connection, the word “detailed text information” means text information which consists of a lot of characters and explains its contents in detail; whereas, the word “abstract text information” means text information which consists of a less number of characters and explains its contents briefly.

When the resolution of the display screen of a receiver terminal for use by its user is lower than a predetermined value or when the size of the display screen is smaller than a predetermined value, the text selecting/processing circuit 244 operates as follows. That is, the program extraction circuit 1201 extracts a program part multiplexed in the received image information therefrom; while the abstract text extraction circuit 1202 extracts abstract text information multiplexed in the received image information therefrom. And the large-size text image generation circuit 1204, on the basis of the abstract text information, generates an image made of a large-size text. Next, the multiplexing circuit 1206 multiplexes the extracted program part and large-size text image to generate image information oriented to a receiver terminal having a small display screen. Finally, the selection circuit 1208 selects and outputs the image information oriented to the small-screen receiver terminal. As a result, the output of the text selecting/processing circuit 244 becomes eventually the image information oriented to the small-screen receiver terminal.

When the resolution of the display screen for use by its user is higher than the predetermined value and the size of the display screen is larger than the predetermined value, on the other hand, the text selecting/processing circuit 244 operates as follows. That is, the program extraction circuit 1201 extracts a program part multiplexed in the received image information therefrom, and the detailed text extraction circuit 1203 extracts a detailed text information multiplexed in the received image information therefrom. And the small-size text image generation circuit 1205, on the basis of the detailed text information, generates an image made of a small-size text. The multiplexing circuit 1207 then multiplexes the extracted program part and small-size text image to generate image information oriented to a receiver terminal having a large display screen. Finally the selection circuit 1208 selects and outputs the image information oriented to the large-screen receiver terminal. As a result, the output of the text selecting/processing circuit 244 becomes eventually the image information oriented to the large-screen receiver terminal.

An example of the extraction method in the program extraction circuit 1201, abstract text extraction circuit 1202 and detailed text extraction circuit 1203 is to perform the extraction based on an identification signal received together with their information or based on an identification signal attached to a packet having information stored therein.

In this connection, explanation has been made in connection with the example where the text information is previously prepared in the form of two of the detailed and abstract text information, but the abstract text information can be obtained by summarizing the detailed text information. In this case, the present invention is arranged so that the output of the detailed text extraction circuit 1203 is applied to an abstract circuit (not shown), the abstract circuit generates abstract text information by summarizing the detailed text information, and an output of the abstract circuit is applied to the large-font text image generation circuit 1204. Further, when the image information always contains no abstract text information, the abstract text information extraction circuit is unnecessary and thus the aforementioned arrangement of using the abstract circuit can be employed.

As has been explained above, with such an arrangement, a less number of but easy-to-see large-size characters can be provided on a small display screen of a receiver terminal; while a more number of characters can be provided on a large display screen of a receiver terminal. In this way, the present invention can distribute a suitable size of display information according to the physical size of the display screen.

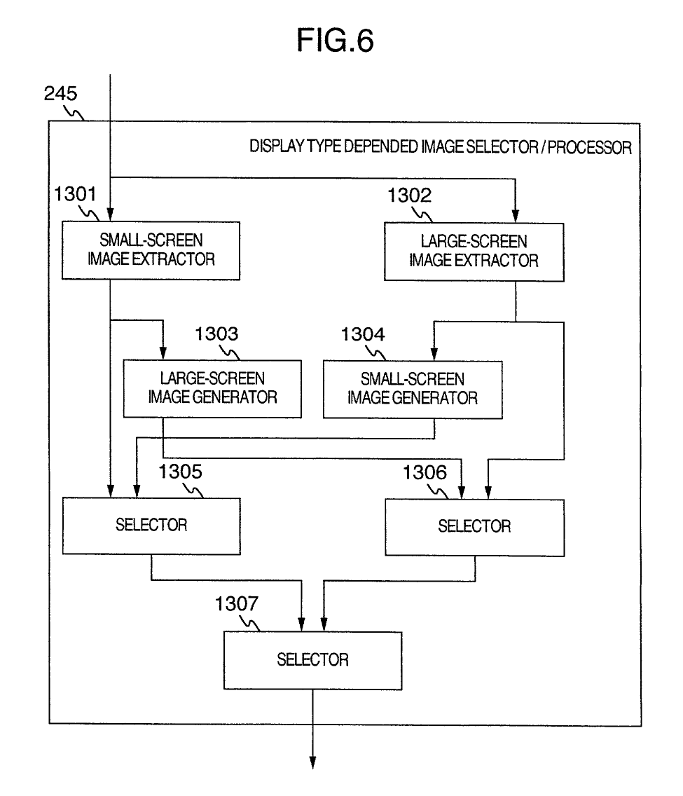

FIG. 6 is a detailed block diagram of an example of the display type depended image selecting/processing circuit 245. The circuit 245 is arranged to distribute easy-to-see image information to a receiver terminal having a small display screen and to distribute easy-to see image information to a receiver terminal having a large display screen. For the purpose of realizing such distribution, the display type depended image selecting/processing circuit 245 selects and/or processes image information so as to display images as materials at the same time or to display a part of an image by cutting it out.

In sports relay broadcasting, for example, it is usually desirable on a large display screen to display an image obtained by photographing a wide range of, e.g., an entire sports stadium or to display a plurality of images obtained by photographing a spot from various angles at the same time; whereas it is usually desirable on a small display screen to display single one of images corresponding to individual athletes at a time. In such a case, the display type depended image selecting/processing circuit 245 selects and/or generates an image corresponding to each athlete for a receiver terminal having a small display screen, and selects an image obtained by photographing a wide range of scene or generates a plurality of small images obtained by photographing it from a plurality of angles to be displayed simultaneously for a receiver terminal having a large display screen. In this way, the different display image selecting/processing circuit 245 can distribute image information suitable for the size of the display screen of each receiver terminal.

In FIG. 6, a small-screen image extraction circuit 1301 extracts an image for a small display screen multiplexed in the received image information therefrom. A large-screen image extraction circuit 1302 extracts an image for a large display screen multiplexed in the received image information therefrom. A large-screen image generation circuit 1303 generates an image for the large display screen from the small-screen image. A small-screen image generation circuit 1304 generates an image for the small display screen from the large-screen image. A selection circuit 1305 selects one of the selected small-screen image received from the small-screen image extraction circuit 1301 and the generated small-screen image received from the small-screen image generation circuit 1304. A selection circuit 1306 selects one of the selected large-screen image received from the large-screen image extraction circuit 1302 and the generated large-screen image received from the large-screen image generation circuit 1303. A selection circuit 1307 selects one of the small-screen image information received from the selection circuit 1305 and the large-screen image information received from the selection circuit 1306. These circuits are controlled by the controller 231 on the basis of the resolution and physical size of the display screen of the receiver terminal of the receiver terminal information included in the operating information.

When the resolution of the display screen of the receiver terminal for use by its user is lower than a predetermined value and the size of the display screen is smaller than a predetermined value, the display type depended image selecting/processing circuit 245 operates as follows. That is, when the small-screen image is multiplexed in the received image information, the small-screen image extraction circuit 1301 extracts the small-screen image therefrom, the selection circuit 1305 selects the extracted small-screen image, and the selection circuit 1307 also selects the extracted small-screen image. As a result, the display type depended image selecting/processing circuit 245 eventually outputs the small-screen image extracted from the received image information. When the small-screen image is not multiplexed in the received image information, on the other hand, the large-screen image extraction circuit 1302 extracts the large-screen image from the received image information, the small-screen image generation circuit 1304 generates a small-screen image from the extracted large-screen image, the selection circuit 1305 selects the generated small-screen image, and the selection circuit 1307 also selects the generated small-screen image. As a result, the display type depended image selecting/processing circuit 245 eventually outputs the generated small-screen image.

When the resolution of the display screen of a receiver terminal for use by its user is higher than the predetermined value and the size of the display screen is larger than the predetermined value, on the other hand, the different display image selecting/processing circuit 245 operates as follows. That is, when the large-screen image is multiplexed in the received image information, the large-screen image extraction circuit 1302 extracts the large-screen image therefrom, the selection circuit 1306 selects the extracted large-screen image, and the selection circuit 1307 also selects the extracted large-screen image. As a result, the display type depended image selecting/processing circuit 245 eventually outputs the large-screen image extracted from the input image information. When the large-screen image is not multiplexed in the input image information, the small-screen image extraction circuit 1301 extracts the small-screen image therefrom, the large-screen image generation circuit 1303 generates a large-screen image from the extracted small-screen image, the selection circuit 1306 selects the generated large-screen image, and the selection circuit 1307 also selects the generated large-screen image. As a result, the display type depended image selecting/processing circuit 245 eventually outputs the generated large-screen image.

An example of the extraction method in the small-screen image extraction circuit 1301 and large-screen image extraction circuit 1302 is to perform the extraction based on a identification signal received together with the input image information or based on an identification signal attached to a packet having the image information stored therein. Another way of the extraction is, as explained in connection with the resolution selecting/processing circuit 242 (see FIG. 3), to extract an image size from the image information and to perform the extraction based on the image size. An example of the method for generating the small-screen image in the large-screen image generation circuit 1303 is to cut out a part of the large display image with use of an auxiliary signal indicative of a position of the cut-out part. For example, when there is an image obtained by photographing an entire sports stadium as the large display screen image, the entire stadium image can be cut into regions having individual sports players shot therein with use of auxiliary signals indicative of the positions of the individual players. At this time, the user can assign the priorities of some of the players to be cut out with use of the operating device 801 and can also select the regions to be cut out according to the specification. Meanwhile, an example of the method for generating the large-screen image in the small-screen image generation circuit 1304 is to display small-screen images shot from a plurality of angles at the same time to form a large-screen image.

As has been explained above, with such an arrangement, a large-screen image can be distributed to an receiver terminal having a large display screen, whereas a small-screen image can be distributed to a receiver terminal having a small display screen.

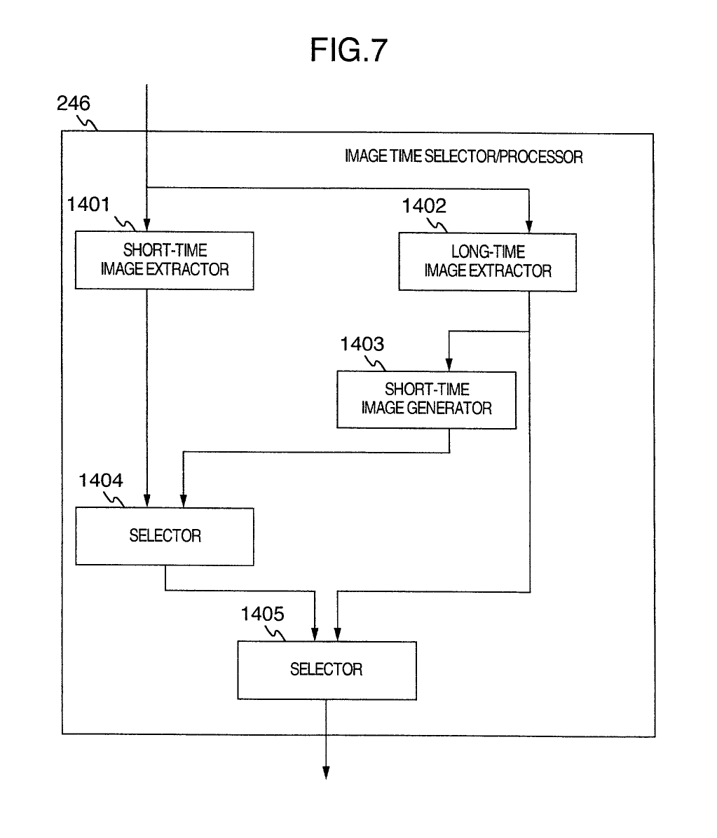

FIG. 7 is a detailed block diagram of an example of the image time selecting/processing circuit 246. For example, in the case of a news image or the like, the news image tends to have a short reproduction time when it is oriented to the portable terminal while the news image tends to have a long reproduction time when it is oriented to the fixed TV set. For this reason, the image oriented to the portable terminal is designed to have a short reproduction time and to allow the user to understand the contents thereof in a short time; whereas the image oriented to the fixed TV set is designed to have a long reproduction time. When the user issues an instruction indicative of short or long image information regardless of the fact that the receiver terminal is of the portable or fixed type, the apparatus is arranged to follow the instruction. For the purpose of realizing such distribution, the image time selecting/processing circuit 246 is provided.

In FIG. 7, a short-time image extraction circuit 1401 extracts short-time image information (which contains digest image information. The same holds true for the following explanation.) multiplexed in image information inputted thereto. A long-time image extraction circuit 1402 extracts long-time image information multiplexed in the input image information. A short-time image generation circuit 1403 generates short-time image information from the long-time image information. A selection circuit 1404 selects one of the extracted short-time image information received from the short-time image extraction circuit 1401 and the generated short-time image information received from the short-time image generation circuit 1403. A selection circuit 1405 selects one of the short-time image information received from the selection circuit 1404 and the long-time image information received from the long-time image extraction circuit 1402. These circuits are controlled by the controller 231 on the basis of information about the fixed or portable type of the receiver terminal, in particular, in the receiver terminal information included in the operating information and on the basis of user's instruction of the reproduction time included in the operating information.

When the user uses a fixed TV set as a receiver terminal or when the user wants a long-time image information, the image time selecting/processing circuit 246 operates as follows. That is, the long-time image extraction circuit 1402 extracts long-time image information multiplexed in the input image information, and the selection circuit 1405 selects the extracted long-time image information. As a result, the image time selecting/processing circuit 246 eventually outputs the long-time image information. When the long-time image information is not multiplexed in the input image information, the short-time image information is used.

When the receiver terminal for use by its user is a portable terminal or when the user wants short-time image information, the image time selecting/processing circuit 246 operates as follows. That is, when the short-time image information is multiplexed in the input image information, the short-time image extraction circuit 1401 extracts the short-time image information from the input image information, the selection circuit 1404 selects the extracted short-time image information received from the short-time image extraction circuit 1401, and the selection circuit 1405 selects the short-time image information received from the selection circuit 1404. As a result, an output of the image time selecting/processing circuit 246 eventually corresponds to the short-time image information extracted from the input image information. When the short-time image information is not multiplexed in the input image information, the long-time image extraction circuit 1402 extracts the long-time image information multiplexed in the input image information therefrom, the short-time image generation circuit 1403 generates the short-time image information from the extracted long-time image information, the selection circuit 1404 selects the generated short-time image information received from the short-time image generation circuit 1403, and the selection circuit 1405 selects the short-time image information received from the selection circuit 1404. As a result, the image time selecting/processing circuit 246 eventually outputs the generated short-time image information.

In this connection, an example of the extraction method in the short-time image extraction circuit 1401 and long-time image extraction circuit 1402 is to perform the extraction based on an identification signal received together with image information or based on an identification signal attached to a packet having the image information stored therein. The method for generating the short-time image information from the short-time image information in the short-time image generation circuit 1403 may employ a known digest image generating method.

As explained above, with the present arrangement, when it is desired to distribute image information oriented to the fixed TV set and when the user wants the long-time image information, the image time selecting/processing circuit 246 can distribute the long-time image information; whereas, when it is desired to distribute image information oriented to the portable terminal and when the user wants the short-time image information, the image time selecting/processing circuit 246 can distribute the short-time image information.

As has been explained in connection with FIGS. 3 to 7, the image selecting/processing circuit 241 having such circuits can convert the image information received from the storage medium 221 to suitable image information conforming to the operating information under control of the controller on the basis of the operating information including the receiver terminal information and distribution line information. That is, the image selecting/processing circuit 241 suitably selects and/or processes the input image information into suitable advertisement image information having a suitable resolution, suitable text information, an image suitable for each of different display screens, and image information satisfying a suitable time. As a result, the user can receive image information most suitable for his receiver terminal and distribution line to watch and listen to it.

The operating device 801 will now be explained in detail.

The operating device 801 can be of any type, so long as it can transmits operating information to the image distribution apparatus 201. Although the operating device 801 is shown as an independent exclusive device in FIG. 1, it may be incorporated in a fixed TV set or portable terminal, as already explained earlier. Especially preferable several forms of the operating device will be explained.

Firstly the fixed TV set 601 already has the function of the operating device 801. In this case, operating information is transmitted to the image distribution apparatus 201 via the high-speed distribution line 401 connected to the fixed TV set 601. Further, since information on the receiver terminal and information on the distribution line are previously known, the receiver terminal information and distribution line information can be automatically included therein. Furthermore, the fixed TV set may be provided with a card insert slot so that, when a card such as an IC card having its user ID previously stored therein is inserted into the slot, the user ID stored in the card is read out to be automatically included in operating information to be transmitted. Or the fixed TV set may be provided with a short-distance wireless communication function, the TV set may be connected with a card or portable terminal having his user ID previously stored therein via short-distance wireless communication, so that the user ID is automatically included in operating information to be transmitted.

Secondly, the portable terminal 701 may have the function of the operating device 801. In this case, operating information is transmitted to the image distribution apparatus 201 via the low-speed distribution line 501 connected to the portable terminal 701. Further, since information on the receiver terminal is previously known, receiver terminal information to be transmitted may be automatically included in the operating information. Furthermore, when the distribution line connected to the portable terminal is known, the distribution line information may also be automatically included in the operating information. In addition, the portable terminal is usually used for private purpose in many cases. Thus since the user ID can be previously stored in the portable terminal, the user ID can be automatically included in the operating information to be transmitted. Like the above case, also, a card insert slot may be provided for a card such as an IC card having the user ID previously stored therein, so that the user ID is automatically included in the operating information to be transmitted.

When the operating device 801 is designed to have such a structure as mentioned above, the user ID information, receiver terminal information and distribution line information are transmitted as included in the operating information to the image distribution apparatus 201. Thus since the need for the user to manually issue these information can be eliminated, the handleability of the apparatus can be improved.

Explanation will now be made as to the detailed operation of the image distribution apparatus of an embodiment of the present invention, together with as to how to break and resume distribution, how to distribute information according to the priority order and how to break and resume the distribution according to the priority order when a plurality of receiver terminals are used as combined and especially when a fixed TV set and a portable terminal are used as combined, which forms one of features of the present invention.

Image information is first input to the image distribution apparatus 201 from the image supply source 101 via the image input part 211. And the input image information is stored in the storage medium 221. The image information contains a plurality of pieces of image information multiplexed with each other so as to be able to cope with the distribution to various types of receiver terminals, as explained above in connection with the image selecting/processing circuit 241. More concretely, the image information includes, for example, a program ID, a program part, an advertisement image part and a text part. The program ID is an ID used for specifying a program. The program and advertisement image parts each contain, as necessary, one or both of image part oriented to high and low resolutions, one or both of image part oriented to large and small display screens, and one or both of image part having short and long reproduction times. The advertisement image part contains one oriented to one or both of home and private use. The text part contains one of one or both of detailed and abstract types.

The user operates the operating device 801 to give an instruction the image distribution apparatus 201 to distribute a desired program. That is, operating information including information about the user ID, program ID, receiver terminal and distribution line is transmitted to the controller 231 within the image distribution apparatus 201 via the operating information input part 251. The user ID is an ID used for judging whether or not the user can receive distribution of the image information from the image distribution apparatus 201 as an authorized user and for specifying the information relating to the user when the user is judged as an authorized user. The receiver terminal information is information such as, e.g., fixed or portable type, resolution and physical size of the display screen, installation place and processing ability. The distribution line information is information about wired or wireless, transmission speed, receiver terminal connected, etc.

In this connection, the receiver terminal information and distribution line information may not be transmitted to the image distribution apparatus 201 in a form included in the operating information, but previously be stored in the storage 301 of the image distribution apparatus 201 and be transmitted in the form of an ID or the like for specification of the receiver terminal and distribution line. Further, the user may assign priorities to desired programs and issues an instruction to want to watch and listen to the programs according to the priority order. In this case, the priority order of the desired programs is included in the operating information, and then transmitted to the image distribution apparatus 201 with sets of the program ID's and priority order levels. Further, the program ID may be excluded from the operating information and the user may give an instruction to assign desired program by its program name or contents. The assignment by the contents means to assign the program not by its program name or program ID but by the contents of the program such as “soccer match”. The assignment by the contents may be any form so long as these program ID, program name and program contents are included in the operating information as information for specifying a program or programs to be distributed, and are transmitted to the image distribution apparatus 201.

In this conjunction, the operating information can be manually transmitted to the image distribution apparatus 201 fully through operation of the operating device 801. Further, some of the operating information may be automatically transmitted to the image distribution apparatus 201. For example, such an arrangement is also possible that the user specifies only program names (or program ID's or program contents) and a priority order, and the user ID, receiver terminal information and distribution line information are automatically transmitted. The automation is the same as already explained in connection with the operating device 801.

And the image distribution apparatus 201, when receiving the operating information, operates as follows. First of all, the controller 231 within the image distribution apparatus 201 accepts the operating information. And the controller 231 refers to a file including the user ID previously stored in the storage 301, and compares the user ID included in the received operating information with the user ID included in the file to authenticate the user. When the user ID included in the received operating information is present in the file stored in the storage 301, the user can accept the distribution from the image distribution apparatus 201 of the present embodiment; and otherwise, the user cannot accept the distribution.

When the user is authenticated to accept the distribution, the controller 231 stores the received operating information in the storage 301. And the controller 231 searches the storage medium 221 for program image information corresponding to the program ID's included in the received operating information stored therein, and transmits the searched image information to the image selecting/processing circuit 241. At this time, a data at which the information was transmitted from the storage medium 221 to the image selecting/processing circuit 241 is previously stored in the storage 301. Under control of the controller 231 based on the receiver terminal information and distribution line information stored in the storage 301, the image selecting/processing circuit 241 selects suitable image information from the input image information and/or processes it into suitable image information and transmits it to the distribution line selection circuit 291. The above operations are the same as those when explained with use of FIGS. 3 to 7. And under control of the controller 231 based on the distribution line information stored in the storage 301, the distribution line selection circuit 291 distributes the input image information to a suitable distribution line.

The image information thus distributed is distributed on the basis of the receiver terminal information and distribution line information included in the operating information received from the operating device 801, so that the image information is distributed via the suitable distribution line to the receiver terminal of the user who wants to watch and listen to it. And the receiver terminal, when receiving the image information, displays the program information and the user can watch and listen to the program.

Explanation will next be made as to the file stored in the storage 301 of the image distribution apparatus 201. The aforementioned various information used in the explanation of the operation of the image distribution apparatus 201 are stored in the file.

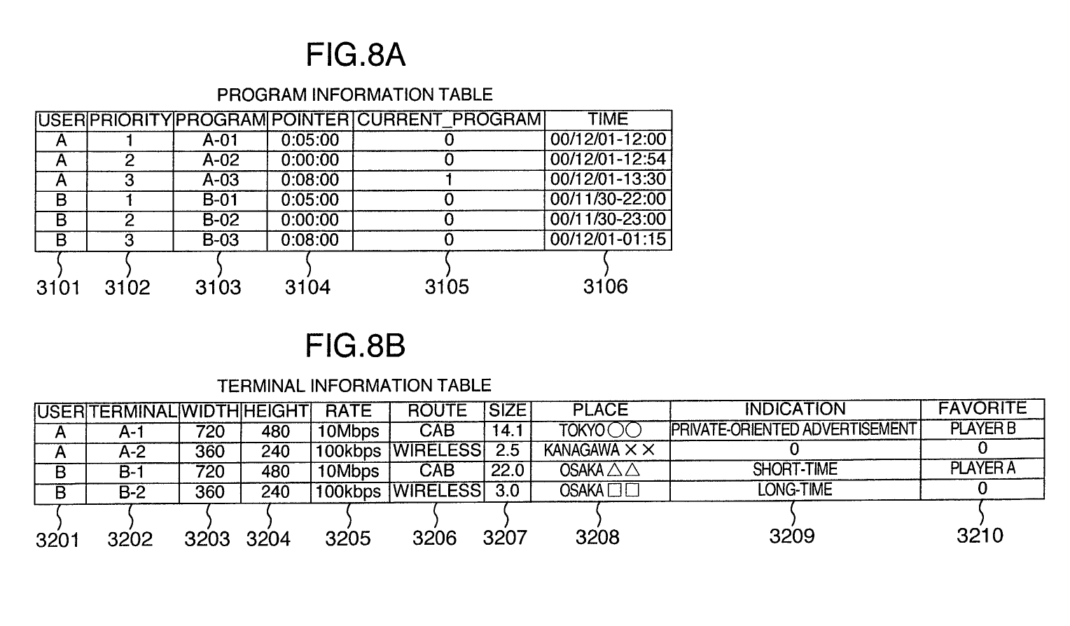

FIGS. 8A and 8B are an example of the file stored in the storage 301 of the image distribution apparatus 201. In FIG. 8A, a user ID 3101 is an ID for identifying the user. A priority order 3102 is the order of programs which the user want to watch and listen to. A program ID 3103 is an ID for specifying a program which the user wants to watch. A pointer 3104 indicates an elapsed time of the program being distributed. A flag 3105 indicates whether or not the program is being distributed. In the illustrated example, the flag 3104 is 1 for a program A-03, and thus it will be seen that the program is being distributed. A time 3106 is a date at which the distribution of the program started.

In FIG. 8B, a user ID 3201 is an ID for identifying the user. A receiver terminal ID 3202 is an ID for identifying the receiver terminal. A width 3203 indicates the width of the display screen of the receiver terminal. A height 3204 indicates the height of the display screen of the receiver terminal. A transmission speed 3205 indicates the transmission speed of the distribution line connected. A route of type 3206 indicates the wireless or cable type of the distribution line. A size 3207 is the size of the display screen of the receiver terminal and expressed in the form of 14.1 inches, 2.5 inches, etc. A place 3208 indicates the place of the receiver terminal. In the case of a fixed TV set, the place 3208 indicates the place where the TV set is installed; while, in the case of a portable terminal, it indicates the place where the portable terminal is present. An indication 3209 is user's indication when advertisement image information is specified in the advertisement image selecting circuit 243 and when the user specifies a program time in the image time selecting/processing circuit 246, as explained above. A favorite 3210 indicates information used when the screen display is cut out in the small-screen image generation circuit 1304 of the different display image selecting/processing circuit 245 as mentioned above. For example, in the case of sport relay broadcasting, a region having user's favorite player shot therein is cut out from image information of the entire sports stadium on the basis of information of the user's favorite player stored in the favorite 3210 to generate a small-screen image.

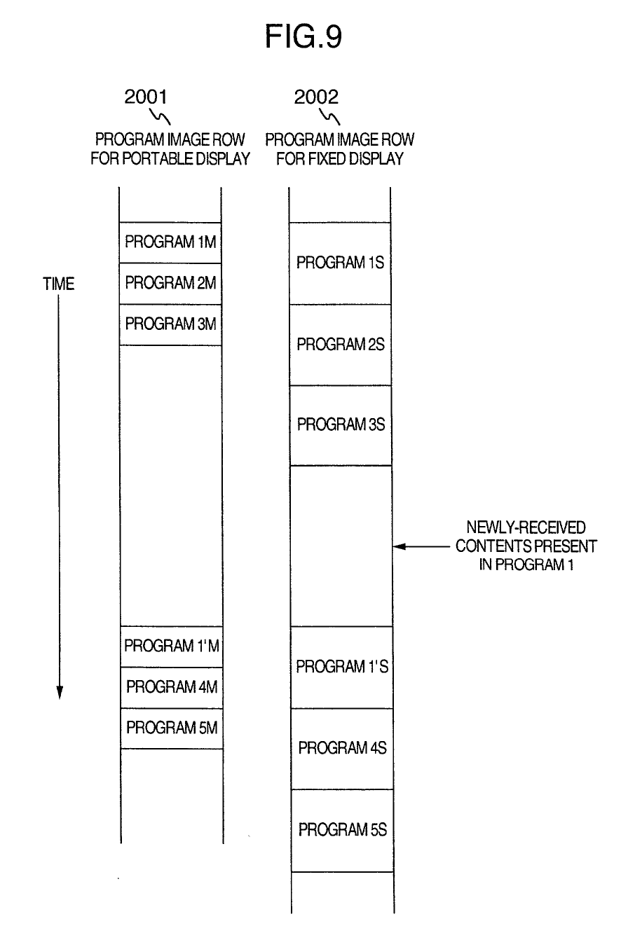

The operation of the image distribution apparatus 201 in its normal distribution mode has been explained above. Explanation will next be made as to the operation of the image distribution apparatus 201 when the user wants to further specify or assign priorities to desired program distribution and when the distribution is broken and thereafter resumed. For easy understanding, prior to this explanation, a specific example of a row of images when the distribution is actually carried out according to the priority order will be briefly explained with reference to FIG. 9.

FIG. 9 shows an example of a row of images distributed according to a priority order. In the case where the user wants to watch and listen to programs 1 to 5 in this order, he interrupts or breaks its watching after finishing watching the programs 1 to 3 on a fixed TV set and some time later, he resumes it on the portable terminal. However, since there is present newly-received contents of the program 1 during the time from its break point to resumption point, it is not important any longer to resume the programs sequentially from the program 4 according to the initial priority order. Thus, when the user resumes the watching of the programs, he first watches it not from the program 4 for the TV set but a program 1′ having the newly-received contents and subsequently watches the programs 4 and 5. The newly-received contents means contents which is newly made and stored in the storage medium 221 and which has substantially the same program name but has a program ID newly assigned.

In FIG. 9, an image row 2001 shows an example of a row of image programs oriented to the portable terminal, while an image row 2002 shows an example of a row of image programs oriented to the fixed TV set. Among the programs, the programs 1s, 2s and 3s are image information actually distributed to the fixed TV set; whereas the programs 1m, 2m and 3m are image information oriented to the portable terminal corresponding to the programs 1s, 2s and 3s, but were not distributed to the portable terminal. And the programs 1′m, 4m and 5m are image information actually distributed to the portable terminal; whereas, the programs 1′s, 4s and 5s are image information oriented to the fixed TV set corresponding to the programs 1′m, 4m and 5m but were not distributed thereto. That is, the user, after watching the programs 1s, 2s and 3s on the fixed TV set, breaks the watching and thereafter watches the programs 1′m, 4m and 5m on the portable terminal.

In this case, with respect to the respective programs, the image row oriented to the fixed TV set and distributed thereto has a long reproduction time per program than that of the image row oriented to the portable terminal and has detailed information more therethan. This is as mentioned above, because the image time selecting/processing circuit 246 of the image selecting/processing circuit 241 in the image distribution apparatus 201 selects and/or processes image information having a long reproduction time for the fixed TV set and image information having a short reproduction time for the portable terminal. When information about the installation place of the receiver terminal is included in the receiver terminal information as when the program 5 is dependent on place as in weather forecast or traffic information, the weather forecast or traffic information at the place of the receiver terminal can be distributed. More specifically, information on the place of the fixed TV set included in the program 5s is distributed to the fixed TV set; whereas information on the place of the portable terminal to be moved included in the program 5m is distributed to the portable terminal.

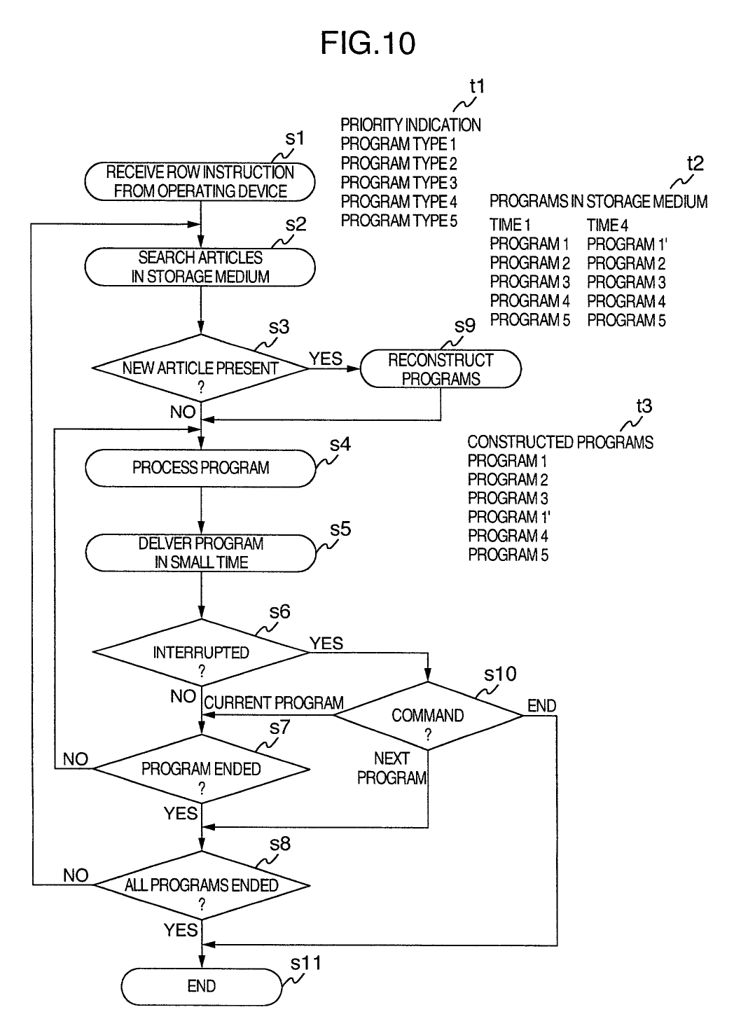

FIG. 10 is a flowchart for explaining an example of the operation of the image distribution apparatus 201 at the time of distributing a row of image program according to a priority order. In this case, explanation will be made in connection with the case where the user assigns priorities to programs 1 to 5 in this order to watch them as explained in FIG. 9, by referring to an actual flow of operations.

In a step S1, first, a user issues an instruction from the operating device 801 to the image distribution apparatus 201 to assign a desired row of image programs and this instruction is received at the image distribution apparatus 201. More in detail, the image distribution apparatus 201 receives operating information including ID's of the programs and the priority order of the programs. And the received operating information is accepted by the controller 231 of the image distribution apparatus 201 and stored in the storage 301. In this example, the image distribution apparatus 201 receives operating information containing the ID's of the programs 1 to 5 and the priority order of the programs and the controller 231 stores it in the storage 301.

In a next step S2, on the basis of the program ID's and priority order of the programs stored in the storage 301, the apparatus searches the storage medium 221 for image information corresponding to the specified programs in the image information stored in the storage medium 221. The programs to be now searched for are programs to be distributed and the programs having priorities higher than those of the programs to be distributed. This means that the apparatus refers to programs for distribution in the Table of FIG. 8, specifies programs to be distributed, compares the priorities of the specified programs with those of other programs to search programs having priorities higher than those of the specified programs. In this example, only the program 1 having the highest priority is first searched. When the apparatus returns again to the step S2 from the next time on, the apparatus searches also for the other programs, which will be explained later.

In a next step S3, the apparatus judges the presence or absence of newly-received contents in the searched programs. More specifically, the apparatus compares a date (distribution start date) of each of the searched programs stored in the Table of FIG. 8 with a date (input date at which the program was input to the image distribution apparatus 201) of the same program stored in the storage medium 221, and when the date stored in the storage medium 221 is more recent than the date of the same program in the Table, the apparatus judges that there is a newly-received contents. Or the apparatus compares the production date included in the image information of each of the searched programs with the date of the same program included in the image information stored in the storage medium 221 and, when the latter date is more recent, the apparatus judges that there is a newly-received contents. When judging the presence of the newly-received contents, the apparatus moves to a step S9 to modify the program to be distributed. When judging absence of any newly-received contents, the program to be distributed is not modified and thus the apparatus moves to a next step S4. In this example, since the program is not distributed yet, there is no newly-received contents and thus the apparatus proceeds to the step S4.

In the step S4, on the basis of the receiver terminal information and distribution line information included in the operating information received from the user, the apparatus selects and/or processes the image information of the program to be now distributed. The processing has already been explained and thus explanation thereof is omitted. After finishing the processing, the apparatus proceeds to a step S5.

In the step S5, the image information arranged and processed in such a manner as mentioned above is actually distributed in units of a very small time. This causes the apparatus to advance the pointer in the Table of FIG. 8A by a distributed amount. The pointer indicates the position at which the program is now distributed. Thus when the distribution is interrupted or broken, the apparatus can know its distribution break point based on the pointer. Also at the beginning of the distribution of the program, the date of the distribution start is previously stored in the Table of FIG. 8A stored in the storage 301. This is for the purpose of using the date when the apparatus judges, at a later stage, the present or absence of newly-received contents in the program, as explained earlier. In this example, the program 1 is first distributed and its distribution start date is previously stored in the storage 301 because it is the first program.

In a step S6, the apparatus judges the presence or absence of a break interrupt from the operating device 801. In the case of generation of a break interruption, the apparatus saves the pointer of the program being distributed and goes to a step S10. In the case of no generation of a break interruption, the apparatus goes to a step S7. In this example, since a break takes place after watching the programs 1 to 3, the apparatus moves to the step S7.

In the step S7, the apparatus judges completion of incompletion of the program being distributed. When judging the completion, the apparatus resets the pointer of the program in question and moves to a step S8. When judging the incompletion, the apparatus again returns to the step S4 and continues the distribution of the program. In this example, the apparatus repeats the steps S4 to S7 to continue the distribution of the program until the distribution of the program 1 is completed. And after completing the distribution of the program 1, the apparatus proceeds to the step S8.

In the step S8, the apparatus judges completion or incompletion of the distribution of all the programs requested by the user. This can be realized by referring to the priority of the program being distributed in the Table of FIG. 8A and, when the priority is the lowest, by judging the completion of all the desired programs. When the distribution of all the programs is completed, the apparatus goes to a step S11 to terminate the operational flow. When the distribution is not completed yet, the apparatus returns to the step S2 to continue the distribution of the subsequent program. In this example, since the distribution of only the program 1 in the programs 1 to 5 requested by the user is finished, the apparatus returns to the step S2 to continue the distribution of the subsequent programs.

With respect to the program 2 to be next distributed, since the program 2 has no newly-received contents and no break point in this example, the operations of the steps S2 to S8 are substantially the same as the above case, except that the programs to be searched in the step S2 are the two of the program 2 to be now distributed and the program 1 having a priority set higher than the priority of the program 2. However, the both programs have no newly-received contents, the apparatus determines the program 2 as a program to be distributed in the step S3.

With respect to the program 3 to be distributed, next, since the programs 1 to 3 have no newly-received contents like the distribution of the program 2 in this example, the distribution operations thereof are substantially the same as those of the program 2, except that programs to be searched in the step S2 are three of the program 3 to be now distributed and the programs 1 and 2 having the priorities set higher than the priority of the program 3 and that a break point takes place. However, since the three programs have no newly-received contents in this example, the apparatus determines the program 3 as a program to be distributed in the step S3. In this example, as mentioned above, after the user finished watching of the program 3, the break point takes place. Accordingly the apparatus goes from the step S6 not to the step S7 but to the step S10 to break the distribution.

In the step S10, the apparatus waits for a next instruction from the operating device 801 under the broken distribution. When receiving an instruction from the operating device, the apparatus judges the contents of the instruction. When the instruction indicates that the user wants to continuously receive the distribution of the program in the break point, the apparatus moves to the step S7 to continue the distribution of the program. When the instruction indicates that the user wants to receive the distribution of the next program, the apparatus goes to the step S8. In these cases, when the user transmits the user ID from the operating device 801, the image distribution apparatus 201 can know the program being stopped by the user and the break point in the program by referring to the Table of FIG. 8A stored in the storage 301, and thus the apparatus can continuously distribute the same program or the next program. Further, in the case where the receiver terminal or distribution line was changed, if the user sends information about the new receiver terminal and distribution line together with the user ID, then the image distribution apparatus 201 can distribute image information of the program. Accordingly the user can resume the distribution on the other receiver terminal. When receiving an instruction indicative of the completion of the distribution, the apparatus goes to a step S11 to terminate the distribution. Even at this time, the user sends the user ID while the image distribution apparatus 201 resets the program ID, priority, etc. of this user stored in the storage 301.

In this example, the user intended to watch the programs 1 to 3 on the fixed TV set and issued a break instruction. And the user issued an instruction to receive the distribution on a portable terminal. Accordingly, in the step S10, the user sends the user ID, the receiver terminal information and distribution line information from the operating device 801 to the image distribution apparatus 201. Assume now that the instruction indicates the selection of the next program. Then the apparatus goes to the step S8. Since the distribution of all the programs is not finished, the apparatus returns to the step S2 to continue the distribution of the next and subsequent programs.

In the step S2, the program 4 to be next distributed as well as the programs 1 to 3 having the priorities set higher than the priority of the program 4 are searched. And when the apparatus judges in the step S3 the presence or absence of newly-received contents of each of the programs. In this example, since newly-received contents exists during a time period from the break point of the program 1 to its resumption, the apparatus judges the presence of newly-received contents and goes to the step S9.

In the step S9, on the basis of information about the program having the newly-received contents and about the programs already distributed, the apparatus reconstructs a row of program image information to be distributed from now. That is, the apparatus deletes the already-distributed program from the program image row to be distributed, and if newly-received contents is present in the already-distributed program, adds image information of the program, and finally arranges these program image information according to the priority order. In this example, the programs 1 to 3 in the programs 1 to 5 are already distributed and thus deleted. And the program 1 in the already-distributed programs 1 to 3 has newly-received contents and changed to the program 1′, and thus the program 1′ is added. When these programs are rearranged in a decreasing order of the priorities, the programs are arranged to be the programs 1′, 4 and 5 in this order. Accordingly, the program to be next distributed is determined to be the program 1′. Since there is no break point after this, the apparatus repeats the steps S4 to S7 to distribute the program 1′.

After the distribution of the program 1′ was finished, there is no newly-received contents and break point in the programs. Thus the apparatus repeats the steps S2 to S8 to distribute the programs 4 and 5. And when the image distribution apparatus 201 judges in the step S8 the completion of distribution of all the programs, the apparatus proceeds to the step S11 to terminate the operation of the apparatus. The programs actually distributed through the above operations are as shown in Table t3.

The operation of the image distribution apparatus 201 has been explained above in connection with the single user. Explanation will next be made when the image distribution apparatus 201 is used by a plurality of users. However, the operation in the case of the plural users is substantially the same as that of the single user, and thus explanation thereof is omitted and explanation will be focused only on different points therebetween.

At the time of starting distribution, first of all, the respective users are required to send their user ID's, program ID's requested by the users, and their receiver terminal ID's to the image distribution apparatus 201. This is carried out as follows.

For example, when the operating device 801 is an exclusive terminal, this is attained by sending operating information having an identical receiver terminal specified therein to the image distribution apparatus 201 from the operating device 801 possessed by each of the users. In this case, each user ID is automatically-transmitted from each operating device 801. With respect to the program ID, all the users may specify the same program or one or some of the users may specify the same program. This is because the apparatus can know that these users try to specify the same program. Or when the operating device 801 is an exclusive terminal, for example, the user ID's of a plurality of users may be combined at the single operating device 801 and then be sent. In this case, at the same time as the above, the specification of receiver terminals and specification of programs may be carried out.

When the operating device 801 is a fixed TV set having the function of the operating device 801 and also having a single card insert slot, for example, users insert their cards into the single slot continuously; whereas, when the number of slots are plural, the users insert their cards into respective slots. Thereby the user ID's of the users are input to the fixed TV set are sent to the image distribution apparatus 201 as included in the operating information. In this case, specification of their receiver terminals and programs are carried out simultaneously with the above procedure. When the operating device 801 is the fixed TV set which has the function of the operating device 801 and also has a short-distance wireless communication function, users carrying their cards or portable terminals having the short-distance wireless communication function can input their user ID's to the fixed TV set by approaching the TV set, at which time the TV set automatically send the user ID's included in operating information to the image distribution apparatus 201. Even in this case, specification of the receiver terminals and programs can be carried out simultaneously with the above procedure.

And the image distribution apparatus 201, when receiving a plurality of user ID's by the above method, refers to the Table of FIGS. 8A and 8B stored in the storage 301 to compare with the received user ID's, and identifies the users on the basis of the compared results. And at the time of starting distribution, the apparatus performs the distribution in such a manner that the pointers of programs to be distributed by all the users become the same. As a result, the pointers of the receiver terminal, program ID and program become the same for all the users, and thus it will be known that the program are watched by the users at the same time.

Next explanation will be as to a case where one of users breaks the watching of the program. In this case, one user is only required to send only his user ID together with his break instruction to the image distribution apparatus 201.

For example, when the operating device 801 is an exclusive device, each user who wants to stop the watching is only required to stop it with use of his operating device 801. This causes his user ID to be automatically sent from the operating device 801 to the image distribution apparatus 201.

When a fixed TV set has the function of the operating device 801 and has a plurality of card insert slots for example, one of the users who wants to stop the watching is only required to remove his card from his slot. When the TV set has a single card insert slot, one user who want to stop the watching is only required to again insert his card into the slot.

When a fixed TV set has the function of the operating device 801 and also has a short-distance wireless communication function, one of the users who wants to stop the watching and carries a card or portable terminal having a short-distance wireless communication function is only required to move away from the TV set. This causes the short-distance wireless communication to become out of its range and the connection to be turned OFF, whereby the TV set automatically sends the disconnected user ID to the image distribution apparatus 201.

When the user ID of the user who wants to stop the watching is sent to the image distribution apparatus 201 by the aforementioned way, the pointer of the user in question in the Table of FIG. 8 stored in the storage 301 is stopped in its counting, and the then pointer is saved as a break point. Thereby the other users can continuously watch the program. Further since the break point of the user who stopped the watching is saved, he can restart the watching of the program anytime from the break point.

Explanation will next be made as to another embodiment of the present invention.

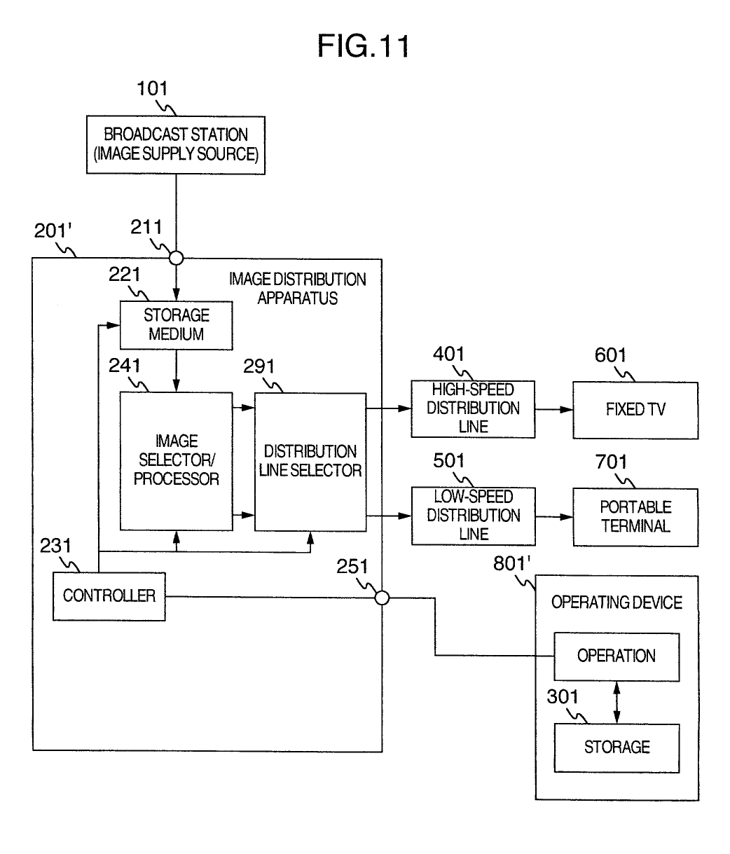

FIG. 11 is a block diagram of an arrangement of an image distribution apparatus 201′ in accordance with another embodiment of the present invention. The present embodiment has substantially the same arrangement as FIG. 1, except that the storage 301 is provided not in the image distribution apparatus 201′ but in an operating device 801′, and thus the same constituent elements as in FIG. 1 are denoted by the same reference numerals and explanation thereof is omitted.

In the present embodiment, the storage 301 is incorporated in the operating device 801′ which moved together with the user, thus eliminating the need for user's identifying operation and a part of the storage of the operating information by the image distribution apparatus 201′. That is, in the case of the image distribution apparatus 201′, while the apparatus stops its distribution, it is unnecessary for the apparatus to keep such contents of the Table of FIG. 8. And at the time of starting the distribution, the apparatus is only required to receive the operating information from the operating device 801′and to store only the received operating information until the distribution is finished.

With such an arrangement, even when the image distribution apparatus 201′ is designed to cope with many users, the apparatus can be made small in size. Further, since the apparatus is required to keep only the operating information received from the operating device 801′ during the distribution, the apparatus can be operated in the same manner as the image distribution apparatus 201.

The embodiment of the present invention has been explained above by referring to the drawings.

Though explanation has been made in the foregoing on the assumption that the image distribution apparatuses 201 and 201′, are independent exclusive apparatuses, the exclusive apparatuses are not necessarily required to be independent of each other. For example, it is possible to obtain the image distribution apparatuses 201 and 201′ by installing a program for causing the aforementioned operations to be implemented in a general computer (especially, video server, or the like) having an input part, control part, storage part, output part, etc. In this case, the respective parts of the computer can function under control of the program, as follows. For example, the input part can function as the image information input part 221 and as the operating information input part 251, the control part can function as the controller 231, image selecting/processing circuit 241 and distribution line selection circuit 291 (in the image distribution apparatuses 201 and 201′), the storage part can function as the storage medium 221 and as the storage 301 (in the image distribution apparatuses 201 and 201′), and the output part can function to distribute the image information. When the respective parts of the computer function in this way, the image distribution apparatuses 201 and 201′ can be obtained with substantially the same effects as those of the aforementioned image distribution apparatuses 201 and 201′. In this case, the program is recorded in a recording medium readable by the computer or is supplied via communication line.

As has been explained in the foregoing, in accordance with the present invention, a suitable image can be distributed according to a receiver terminal. In accordance with the present invention, further, even when a user uses a plurality of receiver terminals and distribution lines, suitable image information can be efficiently distributed.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications falling within the scope of the appended claims.

What is claimed is:

1. An image distribution apparatus comprising:
an image input part which receives image information from an image supply source;
an image storage medium which stores the image information inputted by said image supply source therein;
an operating information input part which inputs operating information including information for specifying a program to be distributed, information relating to a receiver terminal and information relating to a distribution line;
an image selecting/processing circuit, when program image information specified by program specification information included in the image information stored in said image storage medium is suitable image information corresponding to said receiver terminal information, which selects and outputs said suitable image information, and, when the program image information specified by said program specification information included in the image information stored in said image storage medium is not suitable image information corresponding to said receiver terminal information, processes the program image information specified by said program specification information included in the image information stored in said image storage medium into the suitable image information and outputs said processed suitable image information; and
a distribution line selection circuit which selects a suitable distribution line corresponding to said distribution line information and outputs image information outputted from said image selecting/processing circuit to said selected distribution line.

2. An image distribution apparatus comprising:
an image input part which receives a plurality of types of image information for a single program from an image supply source;
an image storage medium which stores the image information inputted to said image input part therein;
an operating information input part which inputs operating information including information for specifying a program to be distributed, information relating to a receiver terminal and information relating to a distribution line;
an image selection circuit which selects suitable image information of program image information specified by program specification information and corresponding to said receiver terminal information among said plurality of types of image information stored in said image storage medium and outputs said suitable image information; and
a distribution line selection circuit which selects a suitable distribution line corresponding to said distribution line information and outputs the image information outputted from said image selection circuit to said selected distribution line.

3. An image distribution apparatus as set forth in claim 2, wherein said receiver terminal information includes type information relating to whether said receiver terminal is of a fixed or portable type, said plurality of types of image information include a plurality of types of advertisement image information, and said image selection circuit selects suitable advertisement image information corresponding to said type information from said plurality of types of advertisement image information stored in said image storage medium.

4. An image distribution apparatus as set forth in claim 2, wherein said receiver terminal information includes information relating to a resolution and physical size of a display circuit of said receiver terminal, said plurality of types of image information include detailed text information and abstract text information, and said image selection circuit, on the basis of said resolution information and physical size information of said display circuit, selects any of said detailed text information and abstract text information stored in said image storage medium and outputs said selected information.

5. An image distribution apparatus as set forth in claim 2, wherein said receiver terminal information includes type information relating to whether said receiver terminal is of a fixed or portable type, and said image selection circuit selects image information of a suitable reproduction time corresponding to said type information from the image information stored in said image storage medium.

6. An image distribution apparatus comprising:
an image input part which receives image information from an image supply source;
an image storage medium which stores the image information received in said image input part therein;
an operating information input part which inputs operating information including information for identifying a program to be distributed, information relating to a resolution and physical size of a display circuit of a receiver terminal, and information relating to a distribution line;
an image processing circuit which receives program image information specified by said program specification information from said image storage medium, and, when the resolution and physical size information of the display circuit indicates that a resolution of said display circuit is lower than a first predetermined value and a physical size of the display circuit is smaller than a second predetermined value, cuts out and outputs a part said received image information, and, when the resolution of said display circuit is higher than the first predetermined value and the physical size of the display circuit is larger than the second predetermined value, processes the received image information into image information by which a plurality of image information can be displayed on a single display screen and outputs said processed image information; and
a distribution line selection circuit which selects a suitable distribution line corresponding to said distribution line information and outputs image information outputted from said image processing circuit to said selected distribution line.

7. An image distribution apparatus comprising:
an image input part which receives image information including detailed text information from an image supply source;
an image storage medium which stores the image information inputted by said image input part therein;
an operating information input part which inputs operating information including information for specifying a program to be distributed, information relating to a resolution and physical size of a display circuit of a receiver terminal, and information relating to a distribution line;
an image processing circuit which receives program image information specified by the program specification information from said image storage medium, and, when information relating to a resolution and physical size of the display circuit of the receiver terminal indicates that the resolution of said display circuit is lower than a first predetermined value or the physical size of the display circuit is smaller than a second predetermined value, processes said detailed text information into abstract text information and outputs the abstract text information; and
a distribution line selection circuit which selects a suitable distribution line corresponding to said distribution line information and outputs image information outputted from said image processing circuit to said selected distribution line.

8. An image distribution apparatus comprising:
an image input part which receives image information from an image supply source;
an image storage medium which stores the image information inputted to said image input part therein;
an operating information input part which inputs information for specifying a program to be distributed, type information relating to whether a receiver terminal is of a fixed or portable type, and information relating to a distribution line;
an image processing circuit which receives program image information specified by said program specification information from said image storage medium, and, when said type information indicates that the receiver terminal is of the portable type, processes the received image information so as to shorten a reproduction time of the received image information and outputs the processed image information; and
a distribution line selection circuit which selects a suitable distribution line corresponding to said distribution line information and outputs image information outputted from said image processing circuit to said selected distribution line.

9. An image distribution apparatus as set forth in claim 1, further comprising:
a storage, when program distribution is interrupted, which stores a break point at which the program distribution was interrupted for each user therein.

10. An image distribution apparatus as set forth in claim 2, further comprising:
a storage, when program distribution is interrupted, which stores a break point at which the program distribution was interrupted for each user therein.

11. An image distribution apparatus as set forth claim 1, wherein said operating information includes priorities of a plurality of programs desired by a user, and wherein, when program distribution is interrupted thereafter distribution of a program is again resumed, and when, with respect to the program being distributed at the time of the interruption and a program already distributed, the programs at the time of the resumption compared with programs at the time of the distribution, have newly-received contents, the program having said newly-received contents and a program not distributed yet are distributed according to the priorities.

12. An image distribution apparatus as set forth in claim 2, wherein said operating information includes priorities of a plurality of programs desired by a user, and wherein, when program distribution is interrupted and thereafter when distribution of a program is again resumed, with respect to the program being distributed at the time of the interruption and a program already distributed, the programs at the time of the resumption are compared with the programs at the time of the distribution so that presence of newly-received contents as a result of the comparison causes the program having said newly-received contents and a program not distributed yet to be distributed according to the priorities.

13. A method for distributing image information in a computer having an input part, control part, storage part and output part, comprising:
an image input step of inputting a plurality of types of image information for a single program from an image supply source by said input part;
an image storage step of storing said inputted image information by said storage part;
an operating information input step of inputting operating information including information for specifying a program to be distributed, information relating to a receiver terminal and information relating to a distribution line by said input part;
a step of searching said storage part for said plurality of types of image information on the basis of said program specification information by said control part;
an image selection step of selecting suitable image information corresponding to said receiver terminal information from said plurality of types of the searched image information by said control part;
a distribution line selection step of selecting a suitable distribution line corresponding to said distribution line information by said control part; and
an image output step of outputting said selected image information to said selected distribution line by said output part.

14. A method as set forth in claim 13, wherein said receiver terminal information includes type information relating to whether said receiver terminal is of a fixed or portable type, said plurality of types of information include a plurality of advertisement image information, and said control part selects suitable advertisement image information corresponding to said type information from said plurality of types of advertisement image information in said image selection step.

15. A method as set forth in claim 13, wherein said storage part, when distribution of a program was interrupted, stores a break point at which the program distribution was interrupted for each user.

16. A method as set forth in claim 14, wherein said storage part, when distribution of a program was interrupted, stores a break point at which the program distribution was interrupted for each user.

17. A method for distribution image information in a computer having an input part, control part, storage part and output part, comprising:
an image input step of inputting image information from an image supply source by said input part;
an image storage step of storing said input image information by said storage part;
an operating information input step of inputting operating information including information for identifying a plurality of programs to be distributed and information relating to priorities for said plurality of programs by said input part; and
a distribution step of specifying programs to be distributed from said stored image information on the basis of said program specification information and distributing image information of said specified programs according to said priorities by said control part,
wherein, when program distribution is interrupted thereafter distribution of a program is again resumed, and when, with respect to the program being distributed at the time of the interruption and a program already distributed, the programs at the time of the resumption, compared with programs at the time of the distribution, have newly-received contents, the program having said newly-received contents and a program not distributed yet are distributed according to the priorities.

18. A computer program product stored on a computer readable medium for distributing image information, said computer program product comprising:
a code for inputting a plurality of types of image information for a single program from an image supply source;
a code for storing said plurality of types of input image information;
a code for inputting operating information including information for identifying a program to be distributed, information relating to a receiver terminal and information relating to a distribution line;
a code for selecting suitable program image information specified by said program specification information and corresponding to said receiver terminal information from said plurality of types of stored image information;
a code for selecting a suitable distribution line corresponding to said distribution line information; and
a code for outputting said selected image information to said selected distribution line.

19. A computer program produce as set forth in claim 18, wherein said receiver terminal information includes type information relating to whether the receiver terminal is of a fixed or portable type, said plurality of types of image information include a plurality of types of advertisement image information, and suitable advertisement image information corresponding to said type information is selected from said plurality of types of advertisement image information.

20. A computer program product stored on a computer readable medium for distributing image information, said computer program product comprising:
a code for inputting image information from an image supply source;
a code for storing said input image information;
a code for inputting operating information including information for identifying a plurality of programs to be distributed and priorities corresponding to said plurality of programs; and
a code for specifying programs to be distributed from said stored image information on the basis of said program specification information and distributing the image information of said specified programs according to said priorities,
wherein, when program distribution is interrupted thereafter distribution of a program is again resumed, and when, with respect to the program being distributed at the time of the interruption and a program already distributed, the programs at the time of the resumption, compared with programs at the time of the distribution, have newly-received contents, the program having said newly-received contents and a program not distributed yet are distributed according to the priorities.

21. An operating device capable of communicating with an image distribution apparatus for distributing stored image information from an image supply source to a fixed or portable type receiver terminal, comprising:
an operating information generation circuit which generats operating information including information relating to the receiver terminal which includes type information relating to whether the receiver terminal is of a fixed or portable type, and information relating to a distribution line; and
an operating information transmission circuit which transmits said generated operating information to said image distribution apparatus.

22. An operating device as set forth in claim 21, further comprising:
a card insert slot which inserts a card having a user ID previously stored therein; and
a card information reader which reads said user ID stored in said card inserted in said card insert slot,
wherein said operating information generation circuit includes the user ID read out from said card into the operating information, and said operating information transmission circuit transmits the operating information including the user ID to said image distribution apparatus.

23. An operating device as set forth in claim 21, further comprising:
a short-distance wireless communication circuit capable of wirelessly communicating with the card or portable terminal having the user ID previously stored therein at a short distance to receive the user ID from said card or portable terminal, and
wherein said operating information generation circuit includes the user ID in the operating information, and said operating information transmission circuit transmits the operating information including the user ID to said image distribution apparatus.

24. An operating device as set forth in claim 21, further comprising:
a storage, when distribution of a program was interrupted, which stores a break point indicative of a position at which the program received from said image distribution apparatus was interrupted.

25. An operating device as set forth in claim 22, further comprising:
a storage, when distribution of a program was interrupted, which stores a break point indicative of a position at which the program received from said image distribution apparatus was interrupted.

26. An operating device as set forth in claim 23, further comprising:
a storage, when distribution of a program was interrupted, which stores a break point indicative of a position at which the program received from said image distribution apparatus was interrupted.
